(19) United States
(12) Patent Application Publication
(10) Pub. No.: US 2026/0181564 A1
(43) Pub. Date: Jun. 25, 2026

(54) POWER HEADROOM FOR SECONDARY CELL

(71) Applicant: Nokia Technologies Oy, Espoo (FI)

(72) Inventors: Samuli Heikki TURTINEN, Oulu (FI); Karri Markus RANTA-AHO, Espoo (FI); Chunli WU, Beijing (CN); Tero HENTTONEN, Espoo (FI)

(21) Appl. No.: 19/127,397

(22) PCT Filed: Nov. 7, 2022
(86) PCT No.: PCT/CN2022/130437

§ 371 Date: May 5, 2025

(51) Int. Cl. H04W 52/36; H04W 74/0833

(52) U.S. Cl. CPC H04W 52/365; H04W 74/0833

(57) ABSTRACT

Embodiments of the present disclosure relate to devices, methods, apparatuses and computer readable storage media for virtual power headroom (PH) calculation for a secondary cell (SCell). The method comprises: obtaining, by a terminal device, information indicative of one or more parameters configured for a first serving cell, wherein the terminal device is connected with at least the first serving cell and a second serving cell; and calculating, by the terminal device, a power headroom value for the second serving cell by applying the one or more parameters configured for the first serving cell.

### FIELD

Various example embodiments of the present disclosure generally relate to the field of telecommunication and in particular, to methods, devices, apparatuses and computer readable storage medium for virtual power headroom (PH) calculation for a secondary cell (SCell).

### BACKGROUND

It has been specified that a User Equipment (UE) may trigger and perform Power Headroom Report (PHR). Substantially, the PHR may indicate that a difference between the nominal UE maximum transmit power and the estimated power for an uplink (UL) transmission on one or more cells associated with the UE. The UE may determine whether a PH value for an activated serving cell is based on real transmission happening on that serving cell or based on reference format which is also called as “a virtual PH”.

### SUMMARY

In general, example embodiments of the present disclosure provide a solution of virtual PH calculation for a SCell.

In a first aspect of the present disclosure, there is provided an apparatus. The apparatus comprises at least one processor; and at least one memory storing instructions that, when executed by the at least one processor, cause the apparatus at least to obtain information indicative of one or more parameters configured for a first serving cell, wherein the apparatus is connected with at least the first serving cell and a second serving cell; and calculate a power headroom value for the second serving cell by applying the one or more parameters configured for the first serving cell.

In a second aspect of the present disclosure, there is provided an apparatus. The apparatus comprises at least one processor; and at least one memory storing instructions that, when executed by the at least one processor, cause the apparatus serving a terminal device being connected with at least a first serving cell and a second serving cell, at least to receive, by the apparatus and from the terminal device, a power headroom report with a power headroom value for the second serving cell, wherein the power headroom value for the second serving cell is calculated by using one or more parameters configured for the first serving cell.

In a third aspect of the present disclosure, there is provided a method. The method comprises: obtaining, by a terminal device, information indicative of one or more parameters configured for a first serving cell, wherein the terminal device is connected with at least the first serving cell and a second serving cell; and calculating, by the terminal device, a power headroom value for the second serving cell by applying the one or more parameters configured for the first serving cell.

In a fourth aspect of the present disclosure, there is provided a method. The method comprises: in a network device serving a terminal device being connected with at least a first serving cell and a second serving cell, receiving, by the network device and from the terminal device, a power headroom report with a power headroom value for the second serving cell, wherein the power headroom value for the second serving cell is calculated by using one or more parameters configured for the first serving cell.

In a fifth aspect of the present disclosure, there is provided an apparatus. The apparatus comprises means for obtaining information indicative of one or more parameters configured for a first serving cell, wherein the apparatus is connected with at least the first serving cell and a second serving cell; and means for calculating a power headroom value for the second serving cell by applying the one or more parameters configured for the first serving cell.

In a sixth aspect of the present disclosure, there is provided an apparatus serving a terminal device being connected with at least a first serving cell and a second serving cell, the apparatus. The apparatus comprises means for receiving, from the terminal device, a power headroom report with a power headroom value for the second serving cell, wherein the power headroom value for the second serving cell is calculated by using one or more parameters configured for the first serving cell.

In a seventh aspect of the present disclosure, there is provided a non-transitory computer readable medium. The non-transitory computer readable medium comprising program instructions that, when executed by an apparatus, cause the apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling diagram of virtual PH calculation for a SCell according to some example embodiments of the present disclosure;

FIG. 3 illustrates a flowchart of a method implemented at a terminal device according to some example embodiments of the present disclosure;

FIG. 4 illustrates a flowchart of a method implemented at a network device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

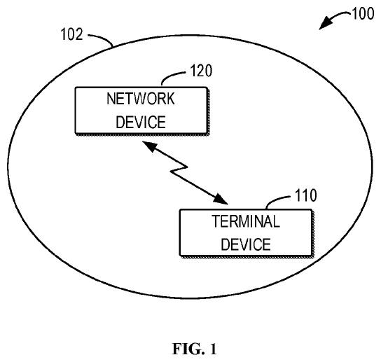

FIG. 1 shows an example communication network 100 in which embodiments of the present disclosure may be implemented. As shown in FIG. 1, the communication network 100 may comprise a terminal device 110. Hereinafter the terminal device 110 may also be referred to as a UE.

The communication network 100 may further comprise a network device 120. Hereinafter the network device 120 may also be referred to as a gNB. The terminal device 110 may communicate with the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, it has been specified that a User Equipment (UE) may trigger and perform PHR. The PHR procedure is used to provide the serving gNB with a Type 1 PH, a Type 2 PH or a Type 3 PH. The Type 1 PH may indicate the difference between the nominal UE maximum transmit power and the estimated power for a physical uplink shared channel, such as transmission per activated serving cell. The Type 2 PH may indicate the difference between the nominal UE maximum transmit power and the estimated power for UL-SCH and Physical Uplink Control Channel (PUCCH) transmission on Special Cell (SpCell) of the other Medium Access Control (MAC) entity. The Type 3 PH may indicate the difference between the nominal UE maximum transmit power and the estimated power for Sounding Reference Signal (SRS) transmission per activated serving cell.

A PHR procedure may be triggered in various scenarios. For example, if a timer associated with the PHR procedure, i.e., a phr-ProhibitTimer or a phr-PeriodicTimer, expires and/or the path loss change meets a threshold value, etc.

The UE may determine whether PH value for an activated serving cell is based on real transmission happening on that serving cell or based on reference format which is also called as “virtual PH”.

Furthermore, the UE may also be configured with multiple Timing Advance Groups (TAGs) where each TAG comes with its own timing and a reference point. Serving cells having UL to which the same timing advance applies and using the same timing reference cell are grouped in a TAG. Each TAG may contain at least one serving cell with configured UL. For a primary TAG, the UE may use the Primary Cell (PCell) as timing reference, except with shared spectrum channel access where an SCell can also be used in certain cases. In a secondary TAG, the UE may use any of the activated SCells of this TAG as a timing reference cell but should not change it unless necessary.

The calculation of the virtual PH may be based on parameters that are provided to the UE within Physical Random Access Channel (PRACH)/Random Access Channel (RACH) configuration. However, a SCell may not be provided with a PRACH/RACH configuration if it is not used as the cell for performing Random Access (RA) for UL timing for a TAG. Hence, how the UE calculates the virtual PH for a serving cell that has no PRACH/RACH configuration may need to be discussed. In some examples, one or more of parameters used for calculation of the virtual PH may comprise preambleReceivedTargetPower, or msg3-DeltaPreamble. In this case, these parameters may be provided within PRACH/RACH configuration. Hence, in some examples, in the below when referring to PRACH/RACH configuration, it may equally mean configuration of preambleReceivedTargetPower and/or msg3-DeltaPreamble.

The solution of the present disclosure proposes a mechanism for calculating the virtual PH for a serving cell, for example, a SCell. In this solution, the terminal device, connecting with at least a first serving cell and a second serving cell, obtains information indicative of one or more parameters configured for a first serving cell and calculate a PH value for the second serving cell by applying the one or more parameters configured for the first serving cell. In this way, the network device may be aware which parameters used by the UE to calculate the virtual PH or the PH value based on the reference format and may, hence, more accurately exploit the received PH value for the SCell scheduling.

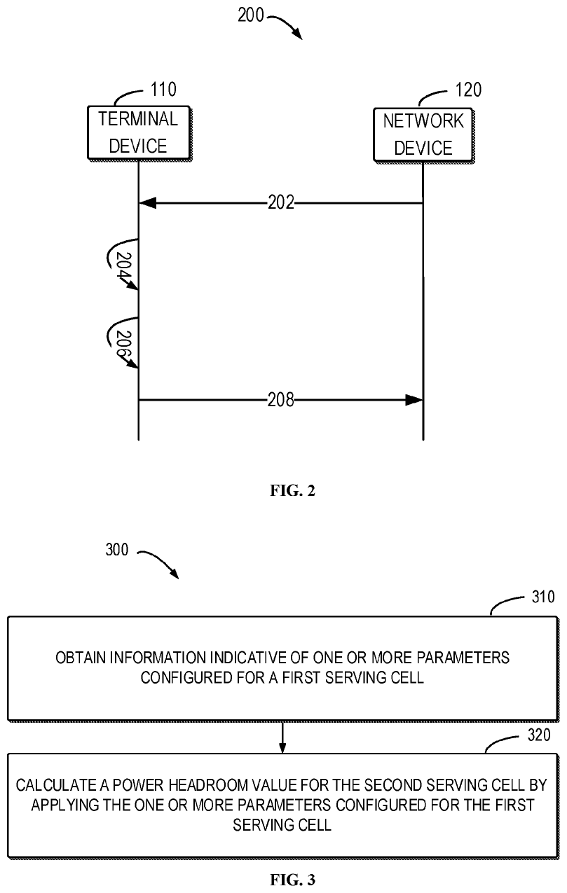

FIG. 2 shows an example signaling diagram of virtual PH calculation for a SCell 200 according to some example embodiments of the present disclosure. For the purposes of discussion, the diagram 200 will be discussed with reference to FIG. 1, for example, by using the terminal device 110 and the network device 120.

Now the reference is made to FIG. 2. In some example embodiments of the present disclosure, the terminal device may be configured 202, by the network device, with UL Carrier Aggregation (CA) with one or more serving cells with UL configuration in a same TAG. In this situation, the terminal device 110 may connect with a plurality of serving cells including at least a first serving cell and a second serving cell.

If the PHR procedure is triggered 204 at the terminal device 110, the terminal device 110 may start to calculate PH values for all activated serving cells.

In this scenario, the terminal device 110 may determine which parameters to be used for the calculation of the PH value for activated serving cells. For example, for the calculation of a virtual PH, the terminal device 110 may determine whether a RACH or a PRACH configuration for a SCell is obtained. If no RACH or PRACH configuration is configured for the SCell, the terminal device 110 may decide to use parameters configured for other serving cell for the calculation of the PH value for the SCell.

In a case where the terminal device is connecting with a first serving cell and a second serving cell (i.e., a SCell), if the terminal device 110 determines that no corresponding parameter(s) are configured for the second serving cell and the first serving cell is configured with the corresponding parameter(s), the terminal device 110 may determine the corresponding parameter(s) are to be used for calculating the PH value for the second serving cell.

In some embodiments, the first and second serving cells may be within a master cell group (MSG). In this situation, the first serving cell may be a PCell and the second serving cell may be a SCell. In another example, the first serving cell and the second serving cell may be SCells.

In some other embodiments, the first and second serving cells may be within a secondary cell group (SCG). In this situation, the first serving cell may be a primary secondary cell (PSCell) and the second serving cell may be a SCell. In another example, the first serving cell and the second serving cell may be SCells.

That is, the first serving cell may be a PCell, a SCell, or a PSCell (the PCell and the PSCell may also be referred as to a Special Cell (SpCell) collectively).

As described above, the terminal device 110 may be configured with multiple TAGs where each TAG comes with its own timing and a reference point. Serving cells having UL to which the same timing advance applies and using the same timing reference cell are grouped in a TAG. For a primary TAG, the terminal device 110 may use the PCell as timing reference, while in a secondary TAG, the terminal device 110 may use any of the activated SCells of this TAG as a timing reference.

In some embodiments, the first and the second serving cell may be within a same TAG. That is, if the TAG is the primary TAG, the first serving cell may be a PCell or a PSCell, i.e., the first serving cell may be a SpCell. If the TAG is the secondary TAG, the first serving cell may be a SCell.

In some example embodiments, if the TAG comes with multiple serving cells with a RACH or PRACH configuration, the terminal device 110 may use the corresponding parameters in a RACH or a PRACH configuration configured for a serving cell with a specified identifier, for example, a lowest or highest serving cell ID (i.e., ServCellIndex) or SCell ID (i.e., SCellIndex). That is, the terminal device 110 may determine the first serving cell based on respective identifier of one or more candidate serving cells from which the corresponding parameters in a RACH or a PRACH configuration can be used by the terminal device 110 to calculate the PH value for the second serving cell.

In some other embodiments, it is also possible that the network device 120 may indicate which one of the PCell, PSCell, SpCell, or SCell configured with a RACH or a PRACH configuration is allowed to be used by the terminal device 110 to calculate the PH value for a SCell. That is, the network device 120 may explicitly indicate which one is the first serving cell to be used for the terminal device 110 to calculate the PH value for the second serving cell. In some examples, the network device 120 may explicitly indicate which one is the first serving cell to be used for the terminal device 110 to calculate the PH value for the second serving cell in a case where both the first and the second serving cells are within the secondary TAG. In this case, the network device 120 may indicate the first serving cell configured with a RACH or a PRACH configuration only within a same TAG.

In some other embodiments, the terminal device 110 may use the parameters of SpCell (i.e., a primary cell or a primary secondary cell) regardless of if the SCell is configured with a RACH or a PRACH configuration. That is, even if the second serving cell is configured with a RACH or a PRACH configuration, the terminal device 110 may also calculate the PH value for the second serving cell by using the corresponding parameters configured for the first serving cell. For example, this mechanism may be required when the first and the second serving cells are within a primary TAG. However, it is to be understood that this mechanism may also be applied when the second serving cell is within a secondary TAG.

After determining which parameters to be used for the calculation of the PH value the terminal device 110 may calculate 206 the PH value for a SCell (e.g., the second serving cell) by using the corresponding parameters of the determined serving cell configured with the RACH or the PRACH configuration (e.g., the first serving cell).

In some other embodiments, the terminal device 110 may indicate 208, to the network device 120, a PHR by using the calculated PH value for the SCell.

In this way, the UE behaviour associated with a PHR procedure may be defined and the network side may be aware which parameters the UE uses to calculate the virtual PH or the PH value based on the reference format and may, hence, more accurately exploit the received PH value for the SCell scheduling.

For example, the solution proposed in the present disclosure may impact the standard in the following:

In some embodiments, if a SpCell is in a same TAG or a same cell group with a SCell, the PH value may be calculated as below.

TABLE 1
an example of impaction of standard

7.7.1 Type 1 PH report
[...]
If the UE determines that a Type 1 power headroom report for an activated serving cell is based on a reference
PUSCH transmission then, for PUSCH transmission occasion i on active UL BWP b of carrier f of
serving cell c , the UE computes the Type 1 power headroom report as
PH_{type1,b,f,c}(i,j,q_{d},l)=\tilde{P}_{CMAX,f,c}(i)−{P_{O}_{_{—}}_{PUSCH,b,f,c}(j)+α_{b,f,c}(j)·PL_{b,f,c}(q_{d})+f_{b,f,c}(i,l)} [dB]
where \tilde{P}_{CMAX,f,c}(i) is computed assuming MPR=0 dB, A-MPR=0 dB, P-MPR=0 dB. T_{C} = 0 dB. MPR,
A-MPR, P-MPR and T_{C} are defined in [8-1, TS 38.101-1], [8-2, TS38.101-2] and [8-3, TS 38.101-3]. The
remaining parameters are defined in Clause 7.1.1 where P_{O}_{_{—}}_{PUSCHb,f,c}(j) and α_{b,f,c}(j) are obtained using
P_{O}_{_{—}}_{NOMINAL}_{_{—}}_{PUSCH,f,c}(0) and p0-PUSCH-AlphaSetId = 0, PL_{b,f,c}(q_{d}) is obtained using
pusch-PathlossReferenceRS-Id = 0, and l = 0, where the parameters configured for the SCell are applied, if
provided for that SCell. Otherwise, the parameters configured for a Serving Cell within the same TAG of that
SCell are applied; in case of primary TAG, parameters configured for SpCell (PCell or PSCell) are applied
and in case of secondaty TAG, parameters configured for an SCell are applied.

In some embodiments, if a PCell is always used for calculating the PH value for a SCell, or performing a PHR procedure, the PH value may be calculated as below.

TABLE 2
an example of impaction of standard

7.7.1 Type 1 PH report
[...]
If the UE determines that a Type 1 power headroom report for an activated serving cell is based on a reference
PUSCH transmission then, for PUSCH transmission occasion i on active UL BWP b of carrier f of
serving cell c , the UE computes the Type 1 power headroom report as
PH_{type1,b,f,c}(i,j,q_{d},l)=\tilde{P}_{CMAX,f,c}(i)−{P_{O}_{_{—}}_{PUSCH,b,f,c}(j)+α_{b,f,c}(j)·PL_{b,f,c}(q_{d})+f_{b,f,c}(i,l)} [dB]
where \tilde{P}_{CMAX,f,c}(i) is computed assuming MPR=0 dB, A-MPR=0 dB, P-MPR=0 dB. TC = 0 dB. MPR,
A-MPR, P-MPR and TC are defined in [8-1, TS 38.101-1], [8-2, TS38.101-2] and [8-3, TS 38.101-3]. The
remaining parameters are defined in Clause 7.1.1 where P_{O}_{_{—}}_{PUSCH,b,f,c}(j) and α_{b,f,c}(j) are obtained using
P_{O}_{_{—}}_{NOMINAL}_{_{—}}_{PUSCH,f,c}(0) and p0-PUSCH-AlphaSetId = 0, PL_{b,f,c}(q_{d}) is obtained using
pusch-PathlossReferenceRS-Id = 0, and l = 0 , where the parameters configured for the SCell are applied, if
provided for that SCell. Otherwise, the parameters configured for the SpCell (PCell or PSCell) are applied.

In some embodiments, if the network side may indicate which serving cell is to be used for calculating the PH value for a SCell, or performing a PHR procedure, the PH value may be calculated as below.

TABLE 3
an example of impaction of standard

7.7.1 Type 1 PH report
[...]
If the UE determines that a Type 1 power headroom report for an activated serving cell is based on a reference
PUSCH transmission then, for PUSCH transmission occasion i on active UL BWP b of carrier f of
serving cell c , the UE computes the Type 1 power headroom report as
PH_{type1,b,f,c}(i,j,qd,l)=\tilde{P}_{CMAX,f,c}(i)−{P_{O}_{_{—}}_{PUSCH,b,f,c}(j)+α_{b,f,c}(j)·PL_{b,f,c}(q_{d})+f_{b,f,c}(i,l)} [dB]
where \tilde{P}_{CMAX,f,c}(i) is computed assuming MPR=0 dB, A-MPR=0 dB, P-MPR=0 dB. T_{C} = 0 dB. MPR,
A-MPR, P-MPR and T_{C} are defined in [8-1, TS 38.101-1], [8-2, TS38.101-2] and [8-3, TS 38.101-3]. The
remaining parameters are defined in Clause 7.1.1 where P_{O}_{_{—}}_{PUSCH,b,f,c}(j) and α_{b,f,c}(j) are obtained using
P_{O}_{_{—}}_{NOMINAL}_{_{—}}_{PUSCH,f,c}(0) and p0-PUSCH-AlphaSetId = 0, PL_{b,f,c}(q_{d}) is obtained using
pusch-PathlossReferenceRS-Id = 0, and l = 0, where the parameters configured for the SCell are applied, if
provided for that SCell. Otherwise, the parameters configured for the serving cell indicated by the network
in ph-ReferenceCell are applied.

Furthermore, a possible RRC configuration of the ph-ReferenceCell may be shown as below.

TABLE 4
an example RRC configuration

| | |
|---|---|
| PHR-Config ::= | SEQUENCE { |
| phr-PeriodicTimer | ENUMERATED {sf10, sf20, sf50, sf100, sf200,sf500, sf1000, infinity}, |
| phr-ProhibitTimer | ENUMERATED {sf0, sf10, sf20, sf50, sf100,sf200, sf500, sf1000}, |
| phr-Tx-PowerFactorChange | ENUMERATED {dB1, dB3, dB6, infinity}, |
| multiplePHR | BOOLEAN, |
| dummy | BOOLEAN, |
| phr-Type2OtherCell | BOOLEAN, |
| phr-ModeOtherCG | ENUMERATED {real, virtual}, |

```
  ...,
  [[
```

| | |
|---|---|
| mpe-Reporting-FR2-r16 | SetupRelease { MPE-Config-FR2-r16 } |

```
    OPTIONAL -- Need M
  ]],
  [[
```

| | |
|---|---|
| mpe-Reporting-FR2-r17 | SetupRelease { MPE-Config-FR2-r17 } |

OPTIONAL, -- Need M

| | |
|---|---|
| twoPHRMode-r17 | ENUMERATED {enabled} |

```
    OPTIONAL -- Need R
  ]],
  [[
```

| | | |
|---|---|---|
| ph-ReferenceCell-r17 | ServCellIndex | OPTIONAL -- Need R |

]]
}

FIG. 3 shows a flowchart of an example method 300 implemented at a terminal device in accordance with some example embodiments of the present disclosure. For the purpose of discussion, the method 400 will be described from the perspective of the terminal device 110 in FIG. 1.

At block 310, the terminal device 110 obtains information indicative of one or more parameters configured for a first serving cell, wherein the terminal device is connected with at least the first serving cell and a second serving cell.

At block 320, the terminal device 110 calculates a PH value for the second serving cell by applying the one or more parameters configured for the first serving cell.

In some example embodiments, the first and second serving cells are within a MSG, or a SCG.

In some example embodiments, the second serving cell is a secondary cell within the MCG or the SCG.

In some example embodiments, the first serving cell is one of the following: a special cell, a primary cell, a primary secondary cell, or a secondary cell within the MCG or the SCG.

In some example embodiments, the first and second serving cells are configured within a same TAG.

In some example embodiments, the TAG is a primary TAG and the first serving cell is one of a special cell, a primary cell, or a primary secondary cell.

In some example embodiments, the TAG is a secondary TAG and the first serving cell is a secondary cell.

In some example embodiments, the first serving cell is determined or selected based on one of a lowest or highest serving cell index, or a secondary cell index.

In some example embodiments, the terminal device 110 may receive, from a network device, an indication indicating the first serving cell to be used for the second serving cell to calculate the power headroom value.

In some example embodiments, the information comprises a physical random access channel, PRACH configuration or a random access channel, RACH, configuration for the first serving cell.

In some example embodiments, the first serving cell is one of: a special cell, a primary cell, or a primary secondary cell, within the MCG or the SCG, regardless of whether a plurality of serving cells are configured with the information indicative of the one or more parameters.

In some example embodiments, the terminal device 110 may calculate the power headroom value for the second serving cell by applying the one or more parameters configured for the first serving cell regardless of whether the second serving is configured with one or more other parameters associated with a calculation of the power headroom value.

In some example embodiments, the second serving cell is not configured with one or more other parameters associated with a calculation of the power headroom value.

In some example embodiments, the power headroom value for the second serving cell relates to a virtual power headroom value.

In some example embodiments, the power headroom value for the second serving cell relates to a power headroom value based on a reference format.

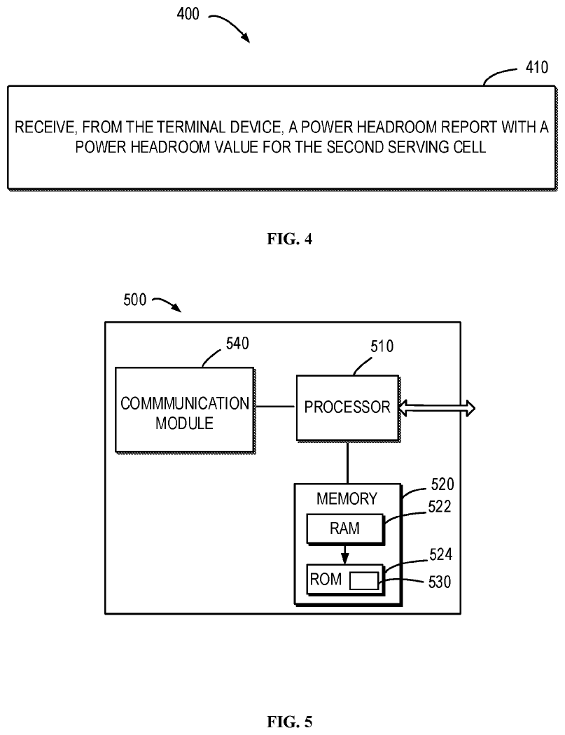

FIG. 4 shows a flowchart of an example method 400 implemented at a network device in accordance with some example embodiments of the present disclosure. For the purpose of discussion, the method 400 will be described from the perspective of the network device 120 in FIG. 1.

At block 410, in the network device 120 serving a terminal device being connected with at least a first serving cell and a second serving cell, the network device 120 receives, by the network device and from the terminal device, a power headroom report with a power headroom value for the second serving cell, wherein the power headroom value for the second serving cell is calculated by using one or more parameters configured for the first serving cell.

In some example embodiments, the first and second serving cells are within a MSG, or a SCG.

In some example embodiments, the second serving cell is a secondary cell within the MCG or the SCG.

In some example embodiments, the first serving cell is one of the following: a special cell, a primary cell, a primary secondary cell, or a secondary cell within the MCG or the SCG.

In some example embodiments, the first and second serving cells are configured within a same TAG.

In some example embodiments, the TAG is a primary TAG and the first serving cell is one of a special cell, a primary cell, or a primary secondary cell.

In some example embodiments, the TAG is a secondary TAG and the first serving cell is a secondary cell.

In some example embodiments, the network device 120 may transmit, to the terminal device, an indication indicating the first serving cell to be used for the second serving cell to calculate the power headroom value.

In some example embodiments, the one or more parameters associated with a physical random access channel, PRACH configuration or a random access channel, RACH, configuration for the first serving cell.

In some example embodiments, the first serving cell is one of: a special cell, a primary cell, or a primary secondary cell, within the MCG or the SCG, regardless of whether a plurality of serving cells are configured with the information indicative of the one or more parameters.

In some example embodiments, the power headroom value for the second serving cell relates to a virtual power headroom value if the second serving cell is not configured with one or more other parameters associated with a calculation of the power headroom value.

In some example embodiments, an apparatus capable of performing any of the method 300 (for example, the terminal device 110 in FIG. 1) may comprise means for performing the respective operations of the method 300. The means may be implemented in any suitable form. For example, the means may be implemented in a circuitry or software module. The apparatus may be implemented as or included in the terminal device 110 in FIG. 1.

In some example embodiments, the apparatus comprises means for obtaining information indicative of one or more parameters configured for a first serving cell, wherein the apparatus is connected with at least the first serving cell and a second serving cell; and means for calculating a power headroom value for the second serving cell by applying the one or more parameters configured for the first serving cell.

In some example embodiments, the first and second serving cells are within a MSG, or a SCG.

In some example embodiments, the second serving cell is a secondary cell within the MCG or the SCG.

In some example embodiments, the first serving cell is one of the following: a special cell, a primary cell, a primary secondary cell, or a secondary cell within the MCG or the SCG.

In some example embodiments, the first and second serving cells are configured within a same TAG.

In some example embodiments, the TAG is a primary TAG and the first serving cell is one of a special cell, a primary cell, or a primary secondary cell.

In some example embodiments, the TAG is a secondary TAG and the first serving cell is a secondary cell.

In some example embodiments, the first serving cell is determined or selected based on one of a lowest or highest serving cell index, or a secondary cell index.

In some example embodiments, the apparatus may also comprise means for receiving, from a network device, an indication indicating the first serving cell to be used for the second serving cell to calculate the power headroom value.

In some example embodiments, the information comprises a physical random access channel, PRACH configuration or a random access channel, RACH, configuration for the first serving cell.

In some example embodiments, the first serving cell is one of: a special cell, a primary cell, or a primary secondary cell, within the MCG or the SCG, regardless of whether a plurality of serving cells are configured with the information indicative of the one or more parameters.

In some example embodiments, the means for calculating the PH value may comprise means for calculating the power headroom value for the second serving cell by applying the one or more parameters configured for the first serving cell regardless of whether the second serving is configured with one or more other parameters associated with a calculation of the power headroom value.

In some example embodiments, the second serving cell is not configured with one or more other parameters associated with a calculation of the power headroom value.

In some example embodiments, the power headroom value for the second serving cell relates to a virtual power headroom value.

In some example embodiments, an apparatus capable of performing any of the method 400 (for example, the network device 120 in FIG. 1) may comprise means for performing the respective operations of the method 400. The means may be implemented in any suitable form. For example, the means may be implemented in a circuitry or software module. The apparatus may be implemented as or included in the network device 120 in FIG. 1.

In some example embodiments, the apparatus serving a terminal device being connected with at least a first serving cell and a second serving cell, the apparatus comprises means for receiving, from the terminal device, a power headroom report with a power headroom value for the second serving cell, wherein the power headroom value for the second serving cell is calculated by using one or more parameters configured for the first serving cell.

In some example embodiments, the first and second serving cells are within a MSG, or a SCG.

In some example embodiments, the second serving cell is a secondary cell within the MCG or the SCG.

In some example embodiments, the first serving cell is one of the following: a special cell, a primary cell, a primary secondary cell, or a secondary cell within the MCG or the SCG.

In some example embodiments, the first and second serving cells are configured within a same TAG.

In some example embodiments, the TAG is a primary TAG and the first serving cell is one of a special cell, a primary cell, or a primary secondary cell.

In some example embodiments, the TAG is a secondary TAG and the first serving cell is a secondary cell.

In some example embodiments, the apparatus may also comprise means for transmitting, to the terminal device, an indication indicating the first serving cell to be used for the second serving cell to calculate the power headroom value.

In some example embodiments, the information comprises a physical random access channel, PRACH configuration or a random access channel, RACH, configuration for the first serving cell.

In some example embodiments, the first serving cell is one of: a special cell, a primary cell, or a primary secondary cell, within the MCG or the SCG, regardless of whether a plurality of serving cells are configured with the information indicative of the one or more parameters.

FIG. 5 is a simplified block diagram of a device 500 that is suitable for implementing example embodiments of the present disclosure. The device 500 may be provided to implement a communication device, for example, the terminal device 110 or the network device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

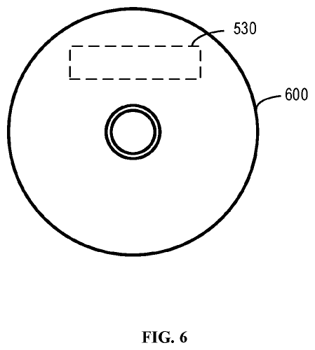

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. An apparatus comprising:
at least one processor; and
at least one memory storing instructions that, when executed by the at least one processor, cause the apparatus at least to:
obtain information indicative of one or more parameters configured for a first serving cell, wherein the apparatus is connected with at least the first serving cell and a second serving cell; and
calculate a power headroom value for the second serving cell by applying the one or more parameters configured for the first serving cell.

33. The apparatus of claim 32, wherein the first and second serving cells are within a master cell group, MCG, or a secondary cell group, SCG.

34. The apparatus of claim 33, wherein the second serving cell is a secondary cell within the MCG or the SCG.

35. The apparatus of claim 33, wherein the first serving cell is one of the following:
a special cell,
a primary cell,
a primary secondary cell, or
a secondary cell,
within the MCG or the SCG.

36. The apparatus of claim 32, wherein the first and second serving cells are configured within a same timing advance group, TAG.

37. The apparatus of claim 36, wherein the TAG is a primary TAG and the first serving cell is one of:
a special cell,
a primary cell, or
a primary secondary cell.

38. The apparatus of claim 36, wherein the TAG is a secondary TAG and the first serving cell is a secondary cell.

39. The apparatus of claim 32, wherein the first serving cell is determined or selected based on one of:
a lowest or highest serving cell index, or
a secondary cell index.

40. The apparatus of claim 32, wherein the apparatus is further caused to:
receive, from a network device, an indication indicating the first serving cell to be used for the second serving cell to calculate the power headroom value.

41. The apparatus of claim 32, wherein the information comprises a physical random access channel, PRACH configuration or a random access channel, RACH, configuration for the first serving cell.

42. The apparatus of claim 32, wherein the first serving cell is one of:
a special cell,
a primary cell, or
a primary secondary cell,
within the MCG or the SCG, regardless of whether a plurality of serving cells are configured with the information indicative of the one or more parameters.

43. The apparatus of claim 32, wherein the apparatus is further caused to:
calculate the power headroom value for the second serving cell by applying the one or more parameters configured for the first serving cell regardless of whether the second serving cell is configured with one or more other parameters associated with a calculation of the power headroom value.

44. The apparatus of claim 32, wherein the second serving cell is not configured with one or more other parameters associated with a calculation of the power headroom value.

45. An apparatus comprising:
at least one processor; and
at least one memory storing instructions that, when executed by the at least one processor, cause the apparatus configured to serve a terminal device being connected with at least a first serving cell and a second serving cell, at least to:
receive, from the terminal device, a power headroom report with a power headroom value for the second serving cell, wherein the power headroom value for the second serving cell is calculated by using one or more parameters configured for the first serving cell.

46. The apparatus of claim 45, wherein the first and second serving cells are within a master cell group, MCG, or a secondary cell group, SCG.

47. The apparatus of claim 46, wherein the second serving cell is a secondary cell within the MCG or the SCG.

48. The apparatus of claim 45, wherein the first serving cell is one of the following:
a special cell,
a primary cell,
a primary secondary cell, or
a secondary cell,
within the MCG or the SCG.

49. The apparatus of claim 45, wherein the apparatus is further caused to:
transmit, to the terminal device, an indication indicating the first serving cell to be used for the second serving cell to calculate the power headroom value.

50. The apparatus of claim 45, wherein the power headroom value for the second serving cell relates to a virtual power headroom value if the second serving cell is not configured with one or more other parameters associated with a calculation of the power headroom value.

51. A method comprising:
obtaining, by a terminal device, information indicative of one or more parameters configured for a first serving cell, wherein the terminal device is connected with at least the first serving cell and a second serving cell; and
calculating, by the terminal device, a power headroom value for the second serving cell by applying the one or more parameters configured for the first serving cell.
